(19) United States
(12) Patent Application Publication
(10) Pub. No.: US 2018/0079307 A1
(43) Pub. Date: Mar. 22, 2018

(54) METHOD AND DEVICE FOR MONITORING A DISPLAY CONTENT

(71) Applicant: DAIMLER AG, Stuttgart (DE)

(72) Inventors: Cora DROYSEN VON HAMILTON, Stuttgart (DE); Steffen SCHNEIDER, Sindelfingen (DE); Peer SMUDA, Sindelfingen (DE)

(21) Appl. No.: 15/566,783

(22) PCT Filed: Mar. 9, 2016
(86) PCT No.: PCT/EP2016/000420

§ 371 Date: Oct. 16, 2017

(30) Foreign Application Priority Data
Apr. 17, 2015 (DE) 10 2015 004 914.3

(51) Int. Cl. B60K 37/06; B60K 35/00; H04L 29/06

(52) U.S. Cl. CPC B60K 37/06; B60K 35/00; B60K 2350/965; B60K 2350/1056; B60K 2350/352; H04L 63/0428

(57) ABSTRACT

A method and a device for monitoring a display content, which includes at least one image symbol and a background, are provided. A monitoring region is defined and a checksum within the monitoring region is formed. At least one encryption element is located in the monitoring region and used for forming the checksum.

### BACKGROUND AND SUMMARY OF THE INVENTION

Exemplary embodiments of the invention relate to a method and a device for monitoring a display content.

Since 2011, the safety standard ISO 26262 has applied for the development of motor vehicles, in particular passenger motor vehicles.

Specific requirements arise from this safety standard, which make it necessary for some warning lights and displays to be implemented “safely” in instrument clusters and for them to be allocated with an Automotive Safety Integrity Level (ASIL).

These displays must be visible to the driver after a guaranteed period of time in order for the driver to be able to react appropriately. With full display instrument clusters, these displays are implemented by graphical display elements.

Here, a potential occurrence of safety-critical defects must be avoided. Potential safety-critical hardware/software defects in full-display instrument clusters are:
1) Exchange of icons. For example: instead of the parking lights, a brake defect is shown.
2) Freezing of the display. The driver cannot recognize that the information displayed is no longer up-to-date.
3) No displays/displays shown too late. The driver is not informed in good time about the vehicle status.

The safety of the displays according to ISO 26262 is achieved by a hardware/software path that loads up the icons to be displayed when an activation request by CAN BUS is received, and displays them at the pre-determined display positions. A second hardware/software path also evaluates the activation request, but also monitors, by way of a checksum comparison, whether the requested display actually also is and remains visible within the predetermined time period at the position provided. Here, a checksum of the current display is calculated and compared with a checksum stored during the development of the control device.

In known methods, the checksums are determined with the aid of pre-defined image regions. Here, a checksum is calculated by way of the pixel colors within the image region. This checksum becomes clear once the image region is sufficiently large that the shape and color of the icon produces a clear pixel pattern.

What is disadvantageous about this solution is that not only the respective icon, but also the background thereof is included in the checksum formation. Therefore, the icon and its background have to be implemented completely statically, since otherwise the checksum comparison would fail in the event of a changing background or animations.

This limitation is a serious problem for an attractive design of full-display instrument clusters, since it makes different color worlds and animations partially impossible.

Accordingly, exemplary embodiments are directed to guaranteeing safe displays by avoiding the aforementioned limitations.

According to an embodiment a method for monitoring a display content that is to be displayed on a display device of a vehicle is provided. Here, it is provided that the display content has an image symbol and a background. A monitoring region is determined by inserting an encryption element within the image symbol and outside the background into the data having the display content to be displayed. The data having the display content to be displayed is transferred to the display device: by using the encryption element in the data having the display content to be displayed, said data having been transferred to the display device, it is determined whether or not the image symbol is displayed without any defects.

Exemplary embodiments are also directed to a device having equipment set up for carrying out the method.

Accordingly, exemplary embodiments provide for monitoring of safety-critical display content using invisible encryption elements, for example in the form of watermarks.

This can advantageously be in accordance with the safety standard ISO 26262.

The checking region or monitoring region is reduced to a very small region, for example 4×4 pixels, such that it is located entirely within a safety-critical image symbol or display element. Since no clear differentiation of the display elements from their outline would be possible any more, at least one invisible and clear encryption element is stored in the form of a watermark on the display element to be monitored.

Therefore, display content can be monitored for its visibility and correct display without limitations in the design of backgrounds or animations. This is particularly advantageous during the use of combined display units in the field of vehicles. According to this, the display instrument according to the invention, for example in the design of an instrument cluster, in particular in a full-display instrument cluster, can be installed in a vehicle.

The visibility of the display elements can, accordingly, be monitored without interdependency with the background, such that a maximum degree of design freedom is enabled. Highly attractive and varying display designs can therefore be incorporated and, at the same time, safety-critical applications and warning lights can be implemented in display instruments.

Further advantages, features and details of the invention result from the following description of a preferred exemplary embodiment as well as with the aid of the drawing. The features and combinations of features specified in the description above and the features and combinations of features specified in the description of the figures and/or in the figures only below can be used not only in the combination specified in each case, but also in other combinations or on their own without exceeding the scope of the invention.

### BRIEF DESCRIPTION OF THE DRAWING FIGURES

Here are shown:

FIG. 1 Monitoring regions for checksum formation according to the prior art; and

FIG. 2 exemplary embodiment of invisibly imprinted watermarks within the monitoring regions according to the invention.

### DETAILED DESCRIPTION

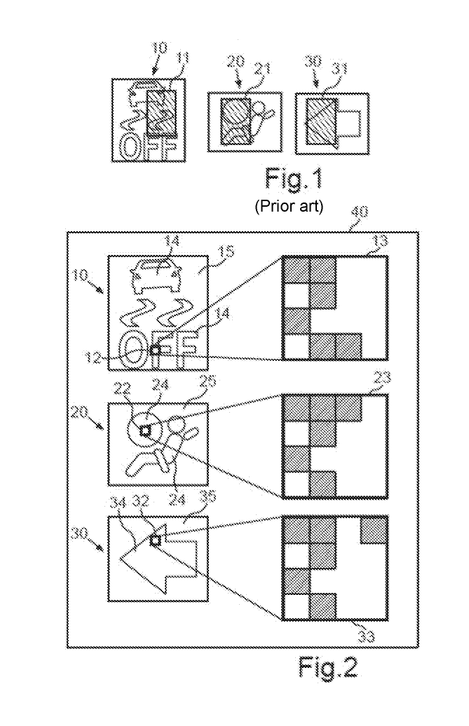

FIG. 1 shows three different display contents or icons 10, 20, 30, each having a monitoring region 11, 21, 31 for checksum formation, in the same manner as is known from the prior art. The checksums are determined with the aid of the pre-defined monitoring regions or image regions 11, 21, 31. Here, a checksum is calculated by way of the pixel colors within each image region 11, 21, 31. This checksum becomes clear once the respective image region 11, 21, 31 is sufficiently large that the shape and color of the respective image region 11, 21, 31 produces a clear pixel pattern.

FIG. 2 shows an exemplary embodiment of a display instrument 40 for monitoring three display contents 10, 20, 30. The display contents 10, 20, 30 each have one or more image symbols 14, 24, 34 on a background 15, 25, 35. The first display content 10 shows several image symbols as a combination with a vehicle and a skid mark above the term “OFF”. The second display content 20 has a background 25 and shows on it a person with a seatbelt on, with a circular symbol in front of the person, as a combination of image symbols 24. The third display content 30 shows an arrow pointing to the left as an image symbol 34 on a background 35. The respective image symbols are located in front of a background, such that an image symbol and a background, here a colored rectangle, together form the display content.

In order to solve the limitations in the design of the backgrounds 15, 25, 35, the respective monitoring regions 12, 22, 23 are reduced so significantly compared to the monitoring regions 11, 21, 31 from FIG. 1 that the checksum formation lies solely within the image symbol 14, 24, 34 to be monitored, as depicted in FIG. 2. If an image symbol 14, 24, 34 is composed of several parts, as is the case for the image symbols 14 and 24, then the use of one part of the image symbol is suitable for defining the monitoring region. By applying the method according to the invention, the backgrounds 15, 25, 35 of the image symbols 10, 20, 30 may now be changed in any way and no longer have any influence on checksum formation.

The significant reduction of the monitoring regions 12, 22, 32 in FIG. 2 leads, however, to these being located on homogeneous color surfaces and therefore the checksums between the different icons 10, 20, 30 no longer being able to be clear. This would prevent clear monitoring of the correct display contents 10, 20, 30 and would not be suitable for a monitoring concept.

Therefore, in addition to the reduced monitoring regions 12, 22, 32, encryption elements 13, 23, 33 in the form of watermarks are used. Clear identification of the safety-critical display contents or display elements 10, 20, 30 can be implemented by means of clear watermarks 13, 23, 33 that are imprinted respectively onto the image symbols 14, 24, 34 at the monitored regions 12, 22, 32. The watermarks 13, 23, 33, as depicted by way of example in FIG. 2, are implemented by a change in the pixel colors that is imperceptible to humans.

From this, the advantages arise that safety-critical displays in display panels are able to be depicted without having to acquiesce to limitations in the design of non-safety-critical content such as background color. Color changes, animations and other dynamic changes can be implemented in order to provide the user with attractive displays that are still compliant with ISO 26262.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-8. (canceled)

9. A method for monitoring a display content to be displayed on a display device of a vehicle, the display content having an image symbol and a background, the method comprising:
defining a monitoring region by inserting an encryption element within the image symbol and outside the background into data having display content to be displayed;
transferring the data having the display content to be displayed to the display device; and
determining whether or not the image symbol is displayed without any defects using the encryption element in the data having the display content to be displayed, wherein the data has been transferred to the display device.

10. The method of claim 9, wherein the determination is performed by comparing the encryption element in the data having the display content to be displayed before the transfer with the encryption element in the data having the display content to be displayed after the transfer.

11. The method of claim 10, wherein the comparison is performed using a checksum of the encryption element in the data having the display content to be displayed before the transfer and a checksum of the encryption element in the data having the display content to be displayed after the transfer.

12. The method of claim 9, wherein the display device is fully digital.

13. The method of claim 9, wherein the display device is an instrument cluster.

14. The method of claim 9, wherein the method satisfies a safety standard according to ISO 26262.

15. The method of claim 9, wherein the monitoring region has a size of 4×4 pixels.

16. A device for monitoring a display content that is to be displayed on a display device of a vehicle, said display content having an image symbol and a background, wherein the device has equipment that is configured to:
define a monitoring region by inserting an encryption element within the image symbol and outside the background into data having display content to be displayed;
transfer the data having the display content to be displayed to the display device; and
determine whether or not the image symbol is displayed without any defects using the encryption element in the data having the display content to be displayed, wherein the data has been transferred to the display device.
